(19) United States
(12) Patent Application Publication
(10) Pub. No.: US 2009/0211854 A1
(43) Pub. Date: Aug. 27, 2009

(54) BUFFER DEVICE OF DISK BRAKE

(76) Inventor: Yuan-Hung WEN, Changhua (TW)

Correspondence Address: Chien-Hui Su, P. O. Box 70-121 Taichung, Taichung City, 40899, TW

(21) Appl. No.: 12/036,305

(22) Filed: Feb. 25, 2008

(51) Int. Cl. F16D 55/46

(52) U.S. Cl. 188/72.2

(57) ABSTRACT

A buffer device of a disk brake comprises a cylinder; the cylinder being installed with at least one piston assembly which has a piston and a push cover. The piston is installed at an inner side and outer side thereof, and the inner side having a receiving chamber for receiving a push cover. A bottom of the receiving chamber is extended upwards with an inner wall. An outer diameter of the push cover is slightly smaller than an inner diameter of the receiving chamber. The push cover has a first end and a second end. The second end of the push cover is corresponding to the inner end of the piston so that second end is received in the receiving chamber. An elastic assembly is installed between the push cover and the piston and the outer sides of the first end and second end are formed as an outer wall.

### FIELD OF THE INVENTION

The present invention relates to bicycle brakes, and particularly to a buffer device of a disk brake, in that elastic assemblies are installed in pistons so as to present two stage braking effects with buffer effect.

### BACKGROUND OF THE INVENTION

Driving bicycle is a popular exercise and widely accepted by peoples. Thus the design of bicycle is improved continuously for the various kinds of bicycles. Other than having beautiful outlooks, safety of the bicycles is also taken into consideration. However under consideration of safety in driving, brakes are the key components. If the brake is not perfect, in high speed, the life of the driver will be threatened, even a great accident occurs.

In U.S. Pat. No. 6,401,882, “heat insulator of disk brake”, in that a disc brake assembly is provided with heat insulators to reduce the heat transferred to the hydraulic fluid of the disc brake assembly during braking. The disc brake assembly includes a caliper housing, a first and a second friction member coupled to the caliper housing and one or more pistons movably coupled to the caliper housing to move one or both of the friction members. The first and second friction members form a rotor receiving slot. At least the first friction member is movably coupled to the caliper housing and the piston is movably coupled to the caliper housing to move the first friction member between a release position and a braking position. Each piston has an internal recess to partially receive the heat insulator. The heat insulator is disposed between the piston and the first friction member to prevent heat transfer from the first friction member to the piston. The heat insulator has a first end with a first end surface received in the recess of the piston, a second end with a second end surface spaced from the first end surface and a side wall extending between the first and second end surfaces. The second end is partially received in the recess of the piston and the side wall has a protrusion extending from the side wall to space the heat insulator from the piston.

The heat from the rapid rotation of the disk is very great. The components are worn due to friction force. In the prior art the friction components are formed with projections for dissipating heat from friction. The piston 21 is installed to heat isolating devices which will suffer the friction force indirectly and thus are easily destroyed. Furthermore, the friction components are directly installed to the piston with any buffer. Both the friction components and piston are easy to wear due to the friction from the disk. Their lifetimes are short. Moreover, the prior art piston uses hydraulic pressure to push the components and then push the braking linings to contact the disk. The disk easily locks deadly so that the tires stop suddenly. In sand or wet ground, the tires will slide so as to generate dangerous accidents.

Therefore, there is an eager demand for a novel device which can improve the above mentioned defects effectively so as to have effectively heat dissipation and the lifetime of the components are prolonged.

### SUMMARY OF THE INVENTION

Accordingly, the object of the present invention is to provide a buffer device of a disk brake, which do not deadly lock the disk brake and have low friction to the components and piston.

To achieve object, the present invention provides a buffer device for a bicycle brake includes a cylinder.

The cylinder is installed in a disk of a vehicle disk brake. The cylinder is formed with a clamping space. In the clamping space, a retaining pin serves to retain a claw portion. Each of two sides of the claw portion has two claw sets. Each set includes an outer claw and an inner claw. One claw set in one side and another claw set in another side of the claw portion serves to clamp a braking lining so that the claw portion can clamp two braking linings. The two braking linings serve to clamp a brake disk. Since an outer side of the braking lining is stopped by the outer claw so that it will not contact the cylinder directly. Thus before braking, a gap is formed between the braking lining and the cylinder. Each to two sides of the cylinder has a receiving groove for receiving a piston assembly. The piston assembly serves to push the braking linings so as to clamp the disk. Each piston assembly in the receiving groove has a piston and a push cover. One of the two piston assemblies has a sealing cover and an oil sealing ring at an outer side of the piston for tightly sealing the piston assembly. An outer side of the piston has an oil sealing ring resisting against the receiving groove so that the piston assembly will seal the receiving groove. Two ends of the piston are an inner side and an outer side. The inner side is formed with a receiving chamber. A bottom of the receiving chamber is installed with positioning block. An inner lateral side of the receiving chamber is formed as an inner lateral wall. An inner annular recess is formed in the inner lateral wall. The receiving chamber will receive the push cover. Two ends of the push cover are a first end and a second end. The second end of the push cover is received in the receiving chamber. The second end of the push cover is formed with a recessed hollow space. A bottom of the hollow space is protruded with a hollow post having a hollow hole which penetrates through the push cover to the first end. Outer sides of the first end and second end of the push cover are formed as an outer wall. An annular groove is formed in the outer wall for receiving a stop ring which is also positioned in the inner annular groove of the receiving chamber so that the push cover is assembled to the receiving chamber. An elastic assembly is installed between the push cover and the piston. The elastic assembly is formed by overlapping a plurality of elastic sheets. Each elastic sheet has an opening at a center thereof. A periphery of the opening has a plurality of slits which are spaced equally. One elastic sheet at one end of the elastic assembly receives a post of the push cover. Another end of the elastic sheet resists against the positioning block in the receiving groove of the piston. The positioning block resists against the elastic assembly to have the effect of positioning.

The present invention provides a heat isolation, fine-adjustable two stage buffer device of a disk brake with the function of heat dissipation. In the present invention, a stop ring is installed between the piston and the push cover. By the stop ring to stop the heat from braking to the hydraulic oil in at an exterior of the piston so that the oil will not deteriorate due to heat. Further the stop ring is installed between the inner annular recess of the piston and the annular groove of the push cover. The push cover has a margin to move with respect to the piston. Therefore, even the push cover do not contact the braking lining in parallel, the stop ring will automatically fine adjust to match the orientation of the braking linings. The claw portion of the present invention includes the inner claws and outer claws so that a gap is formed between the braking linings and the cylinder. Thus, the piston is pushed by hydraulic pressure, the piston, push cover and elastic assembly will move through the gap to push the braking linings so that the braking linings clamps the disk to have the first stage braking effect. If the user pushes the piston continuously by hydraulic pressure, the piston moves inwards continuously so that the elastic assembly will compress through a distance of the gap so as to have the second stage braking effect. By the first stage initial braking effect, through the elastic margin of the elastic assembly, the disk will not be deadly locked and the rotation speed of the disk is decreased. Then the second stage braking is performed so as to have the two stage braking effect. In braking, friction will generate great heat. In the present invention, the elastic assembly is compressed by air, the heat from friction will drain out from the hollow post in the push cover to avoid heat transfer to the piston and thus the hydraulic oil is deteriorate. In the second embodiment of the present invention, an outer wall of the push cover is installed with outer trenches for assisting the post to exhaust hot air inwards so as to have preferred heat dissipation effect.

The various objects and advantages of the present invention will be more readily understood from the following detailed description when read in conjunction with the appended drawing.

### BRIEF DESCRIPTION OF THE DRAWINGS

FIG. 1 is an explosive schematic view of the buffer device of a disk brake of the present invention.

FIG. 2 is an assembled schematic view of the buffer device of a disk brake of the present invention.

FIG. 3 is a schematic view showing that the buffer device of a disk brake of the present invention is installed to a disk.

FIG. 4 is a schematic cross sectional view showing that the claw portion of the present invention clamps the braking linings according to the present invention.

FIGS. 5 to 7 are schematic cross sectional view showing the operation of the first embodiment along line A-A of FIG. 2.

FIG. 8 is a schematic cross sectional view about the push cover in the second embodiment of the present invention.

FIGS. 9 to 11 are schematic cross sectional views along line AA′ in FIG. 2 according to the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

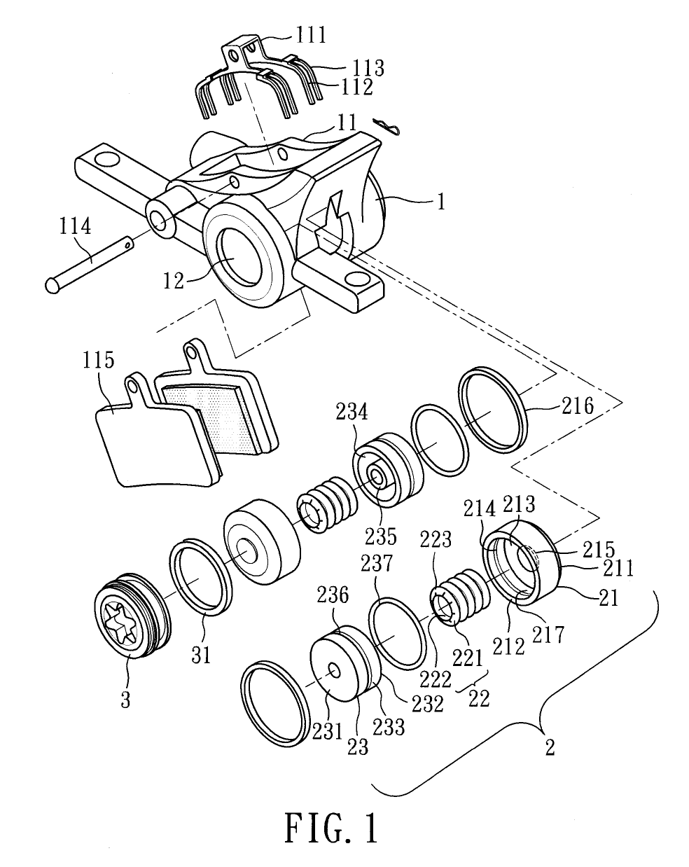

The present invention relates to a buffer device of a disk brake, as illustrated in FIGS. 1 to 4, the present invention includes a cylinder 1.

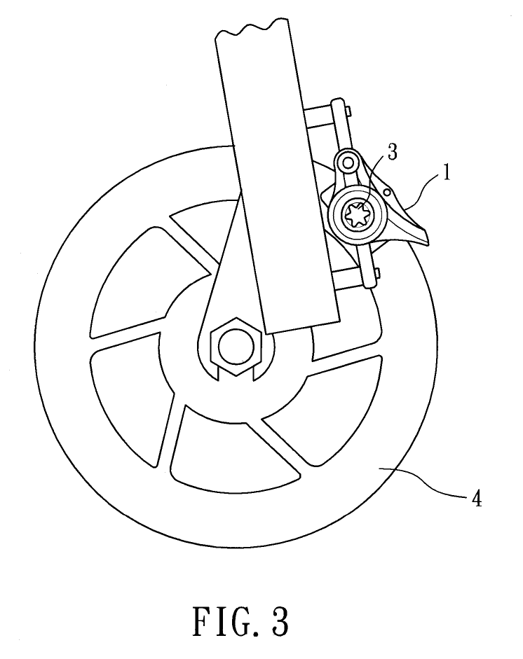

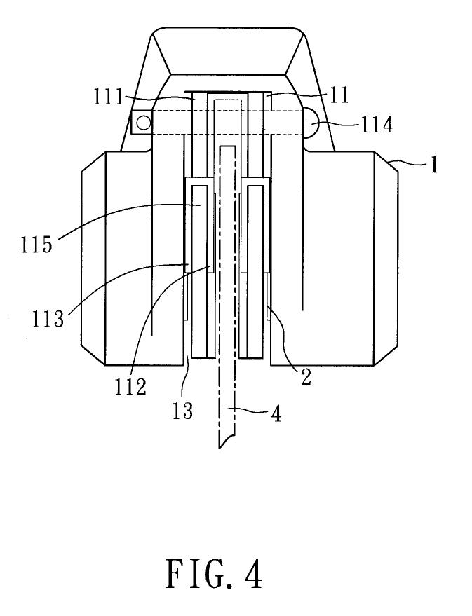

The cylinder 1, as shown in FIG. 3, is installed in a disk 4 of a vehicle disk brake. The cylinder 1 is formed with a clamping space 11. In the clamping space 11, a retaining pin 114 serves to retain a claw portion 111. Each of two sides of the claw portion 111 has two claw sets. Each set includes an outer claw 113 and an inner claw 112. One claw set in one side and another claw set in another side of the claw portion 111 serves to clamp a braking lining 115 so that the claw portion 111 can clamp two braking linings 115. The two braking linings 115 serve to clamp a brake disk 4, as shown in FIG. 4. Since an outer side of the braking lining 115 is stopped by the outer claw 113 so that it will not contact the cylinder 1 directly. Thus before braking, a gap 13 is formed between the braking lining 115 and the cylinder 1. Each to two sides of the cylinder 1 has a receiving groove 12 for receiving a piston assembly 2. The piston assembly 2 serves to push the braking linings 115 so as to clamp the disk 4.

Each piston assembly 2 in the receiving groove 12 has a piston 21 and a push cover 23. One of the two piston assemblies 2 has a sealing cover 3 and an oil sealing ring 31 at an outer side of the piston 21 for tightly sealing the piston assembly 2. An outer side of the piston 21 has an oil sealing ring 216 resisting against the receiving groove 12 so that the piston assembly 2 will seal the receiving groove 12. Two ends of the piston 21 are an inner side 212 and an outer side 211. The inner side 212 is formed with a receiving chamber 213. A bottom of the receiving chamber 213 is installed with positioning block 215. An inner lateral side of the receiving chamber 213 is formed as an inner lateral wall 217. An inner annular recess 214 is formed in the inner lateral wall 217. The receiving chamber 213 will receive the push cover 23.

Two ends of the push cover 23 are a first end 231 and a second end 232. The second end 232 of the push cover 23 is received in the receiving chamber 213. The second end 232 of the push cover 23 is formed with a recessed hollow space 234. A bottom of the hollow space 234 is protruded with a hollow post 235 having a hollow hole which penetrates through the push cover 23 to the first end 231. Outer sides of the first end 231 and second end 232 of the push cover 23 are formed as an outer wall 233. An annular groove 236 is formed in the outer wall 233 for receiving a stop ring 237 which is also positioned in the inner annular groove 214 of the receiving chamber 213 so that the push cover 23 is assembled to the receiving chamber 213. An elastic assembly 22 is installed between the push cover 23 and the piston 21.

The elastic assembly 22 is formed by overlapping a plurality of elastic sheets 221. Each elastic sheet 221 has an opening 222 at a center thereof. A periphery of the opening 222 has a plurality of slits 233 which are spaced equally. One elastic sheet 221 at one end of the elastic assembly 22 receives a post 235 of the push cover 23. Another end of the elastic sheet 221 resists against the positioning block 215 in the receiving groove 12 of the piston 21. The positioning block 215 resists against the elastic assembly 22 to have the effect of positioning.

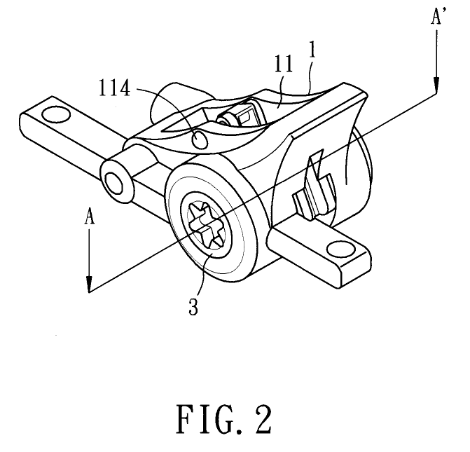

With referring to FIG. 2, in assembly of the present invention, the receiving grooves 27 at two sides of the clamping space 11 are received with the piston assembly 2. One end of the piston assembly 2 is added with the sealing cover 3 and the oil sealing ring 31. Then the piston 21, elastic assembly 22 and push cover 23 are assembled from the outer side to the inner side. A periphery of the piston 21 is installed with the oil sealing ring 216 so that the hydraulic pressure of the disk brake do not drain out. The stop ring 237 is installed between the piston 21 and the push cover 23. The stop ring 237 serves to transfer heat generated at braking operation to an interior of the piston 21 to avoid quality deterioration due to overheat. In use, as no braking is performed, the gap 13 is existed between the braking lining 115 and the piston assembly 2. Oil pressure will push the piston 21, so that the piston 21, the push cover 23 and the elastic assembly 22 will push the braking linings 115 to clamp the disk 4 to have the effect of first stage braking. If the user moves continuously, the piston 21 will be pushed by oil pressure. The piston 21 will push inwards so that the elastic assembly 22 will cause the gap 13 to be smaller so as to have the second stage braking effect.

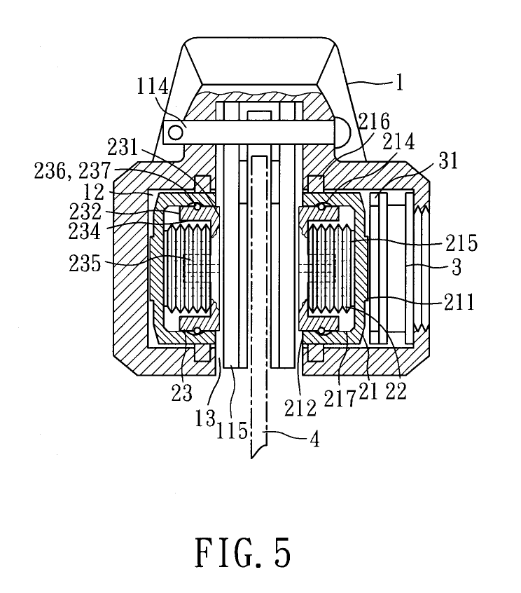

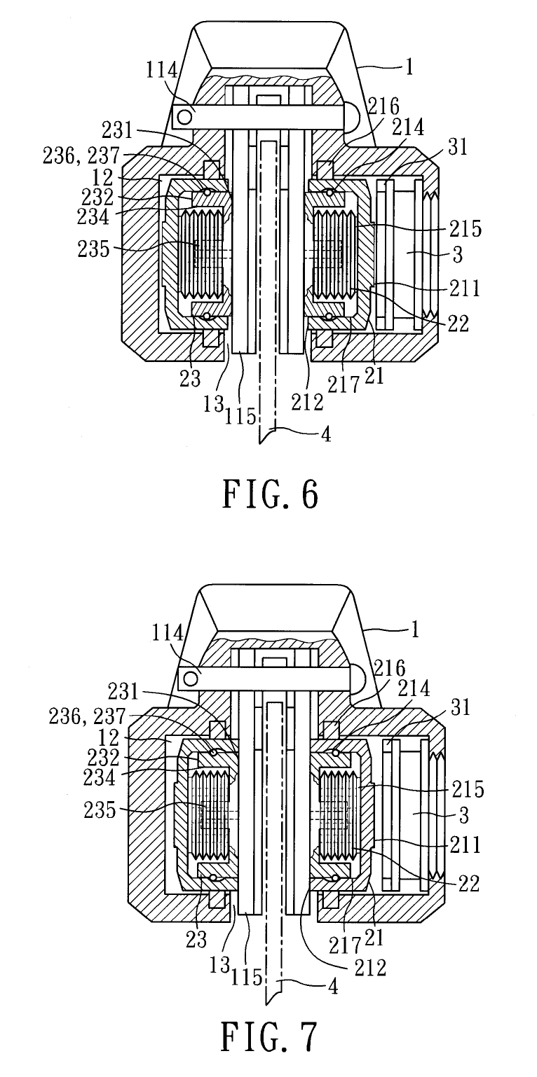

Referring to FIGS. 5 to 7, initially, as illustrated in FIG. 5, the outer claw 113 will stop outer side of the braking lining 115 so as to has a distance of the gap with the piston assembly 2. The piston assembly 2 is not pushed by hydraulic pressure to be in the initial state. The push cover 23 is not in contact with the braking lining 115. When braking, the hydraulic pressure pushes the piston assembly 2, as illustrated in FIG. 6, the piston 21, elastic assembly 22 and push cover 23 moves inwards corresponding to the push cover 23 resists against the braking lining 115, and the braking linings 115 will clamp the disk 4, but since the elastic assembly 22 is elastic, the disk 4 is not deadly locked, the braking lining 115 has a margin for pushing backwards. Therefore, the first stage fine braking is achieved. If the pressure is given continuously, as illustrated in FIG. 7, the hydraulic pressure will push the piston 21 to move inwards, and then the piston 21 will resists against the elastic assembly 22 so that the piston 21 pushes the braking linings 115. The elastic assembly 22 is compressed so as to generate a resilient force to push the piston 21 and the push cover 23. Therefore, a second tightening braking effect is achieved. Because the piston 21 and the push cover 23 push the braking linings 115 at the same time. The contact area between the piston assembly 2 and the braking linings 115 is increased so as to increase the pushing force. Furthermore, the resilient force of the elastic assembly 22 will cause that the braking linings 115 to tightly clamp the disk 4 so as to have the buffer effect in the two stage braking.

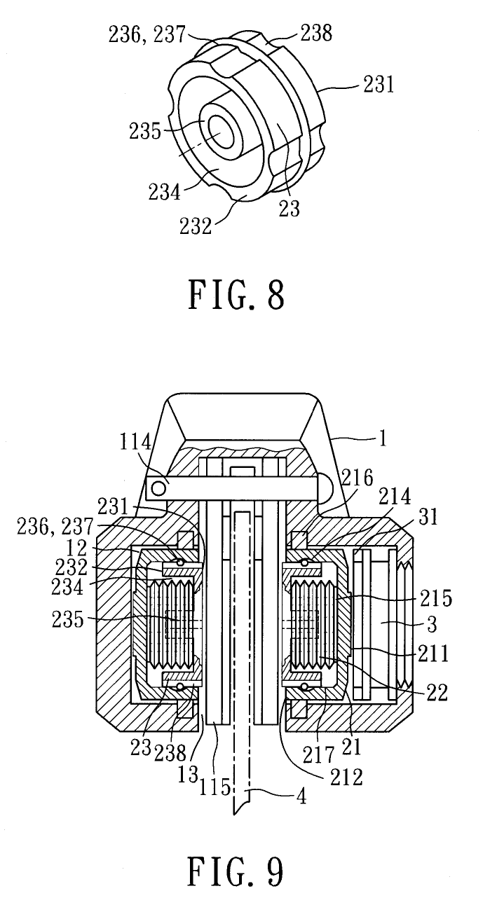

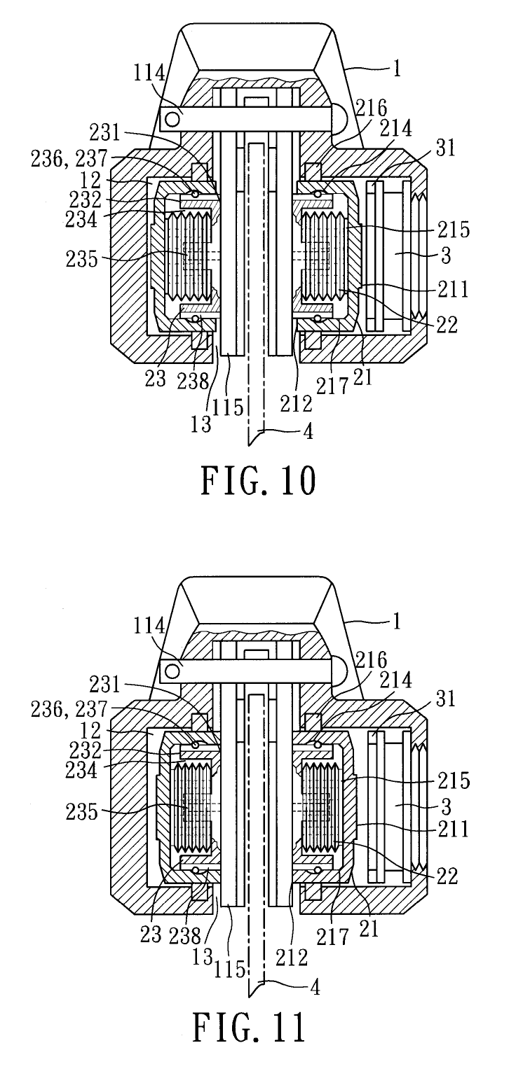

Referring to FIG. 8, the second the present invention of the present invention is illustrated. An outer wall 233 of the push cover 23 is formed with a plurality of outer trenches 238 which extends from the second end 232 to the first end 231. An outer wall 233 of the push cover 23 has an annular grooves 236 for receiving a stop ring 237. Referring to FIGS. 9 to 11 the operation of the present invention is illustrated. In use, hydraulic pressure will push the piston 21, the elastic assembly 22, and push cover 23 to push the braking linings 115 to move through a distance of the gap 13 so as to have the first stage braking effect. If the piston 21 is pushed continuously, the piston 21 will compress the elastic assembly 22 to push the braking linings 115. The elastic assembly 22 pushes the push cover 23 and the braking linings 115 are pushed with a greater force as to have the second stage braking effect. Since in braking, the friction will generate heat energy, in the present invention, the hollow elastic sheets 221 will dissipate heat from the post 235 of the push cover 23. With the outer trenches 238 in the outer wall 233 of the push cover 23, the heat will drain out. By the stopping effect of the stop ring 237, heat is transferred to an outer side of the piston 21 to have the effect of heat dissipation, and avoiding the quality deterioration of the hydraulic oil.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A buffer device of a disk brake comprising: a cylinder; the cylinder being installed with at least one piston assembly; the piston assembly having a piston and a push cover; wherein
the piston is installed at an inner side and outer side thereof, and the inner side having a receiving chamber for receiving a push cover; a bottom of the receiving chamber is extended upwards with an inner wall;
an outer diameter of the push cover is slightly smaller than an inner diameter of the receiving chamber; the push cover has a first end and a second end; the second end of the push cover is corresponding to an inner side of the piston so that second end is received in the receiving chamber; an elastic assembly is installed between the push cover and the piston and the first end and second end of the push cover are formed as an outer wall;
wherein since the elastic assembly is installed between the piston and the push cover, when the push cover is pushed, the elastic assembly has a buffer effect.

2. The buffer device of a disk brake as claimed in claim 1, wherein the outer wall of the push cover and the inner wall of the piston are installed with a stop ring so that the push cover is assembled to the receiving chamber of the piston.

3. The buffer device of a disk brake as claimed in claim 1, wherein the elastic assembly is formed by overlapping a plurality of elastic sheets so as to have the buffer effect.

4. The buffer device of a disk brake as claimed in claim 1, wherein the elastic assembly is formed by overlapping a plurality of elastic sheets, a center of each elastic sheet has an opening; and an inner edge of each opening is formed with a plurality of slits so as to have the buffer effect.

5. The buffer device of a disk brake as claimed in claim 1, wherein the second end of the push cover has a receiving space for assembling the elastic assembly.

6. The buffer device of a disk brake as claimed in claim 1, wherein the second end of the push cover has a receiving space for assembling the elastic assembly and a center of the receiving space is protruded with a hollow post for receiving the elastic assembly so as to position the elastic assembly.

7. The buffer device of a disk brake as claimed in claim 1, wherein the cylinder has a claw portion; each of two sides of the claw portion has two claw sets; each set includes an outer claw and an inner claw-, one claw set in one side and another claw set in another side of the claw portion serves to clamp a braking lining so that the claw portion can clamp two braking linings; an outer side of the braking lining is stopped by the outer claw so that it will not contact the cylinder directly; thus before braking, a gap is formed between the braking lining and the cylinder.

8. The buffer device of a disk brake as claimed in claim 1, wherein an inner side of the piston has a receiving chamber; a positioning block is installed in the receiving chamber for assembling the elastic assembly.

9. The buffer device of a disk brake as claimed in claim 1, wherein an outer wall of the push cover is formed with an annular groove and a middle section of an inner wall of the piston is formed with an inner annular recess, by the annular groove of the push cover and the inner annular recess of the piston, the push cover can be assembled to the piston.
